(19) United States
(12) Patent Application Publication
(10) Pub. No.: US 2026/0365168 A1
(43) Pub. Date: Nov. 19, 2026

(54) CONTROL DEVICE FOR A VEHICLE, VEHICLE SYSTEM, AND METHOD OF CONTROLLING A VEHICLE

(71) Applicant: ZF Systems Europe BV, Brussels (BE)

(72) Inventors: Ashok Kumar Kumar, Dharmapuri (IN); Harish Chidambara Subramania Iyer, Trivandrum (IN); Myilavan Palanivel, Perambalur(DT) (IN); Prabhakaran Durairaj, Chennai (IN); Ganesamoorthy Arumugam, Chennai (IN)

(21) Appl. No.: 19/722,402

(22) Filed: Jun. 26, 2026

Related U.S. Application Data
(63) Continuation of application No. PCT/EP2024/083570, filed on Nov. 26, 2024.

(30) Foreign Application Priority Data
Dec. 26, 2023 (IN) 202311088829

(51) Int. Cl. B60W 30/18; B60R 16/023; B60W 10/06; B60W 10/184; F02D 41/02

(52) U.S. Cl. CPC B60W 30/18054; B60R 16/0231; B60W 10/06; B60W 10/184; F02D 41/021; B60W 2510/186; B60W 2520/10; B60W 2710/0666; B60W 2710/186; F02D 2200/50

(57) ABSTRACT

A control device is for a vehicle. The vehicle has a brake cylinder having a parking brake chamber configured such that a brake state is controllable by a pressure in the parking brake chamber. The control device includes at least one processing circuit configured to trigger a torque limiting action to limit an engine torque in response to a trigger condition that is dependent at least on the pressure in the parking brake chamber.

### CROSS-REFERENCE TO RELATED APPLICATIONS

This application is a continuation application of international patent application PCT/EP2024/083570, filed Nov. 26, 2024, designating the United States and claiming priority from Indian application 202311088829, filed Dec. 26, 2023, and the entire content of both applications is incorporated herein by reference.

### TECHNICAL FIELD

The disclosure relates to a control device for a vehicle, a vehicle system, and a method of controlling a vehicle. Embodiments of the disclosure relate to a control device and a method configured for use with a vehicle having a pneumatically controlled parking brake.

### BACKGROUND

Many vehicles include a parking brake. A pneumatically controlled parking brake is a type of braking system that uses compressed air to engage and disengage the parking brake. A pneumatically controlled parking brake is often found in commercial vehicles like trucks and buses, where it offers various technical advantages. Commercial vehicles often carry heavy loads and operate in diverse environments. The pneumatic parking brake system provides reliable and robust operation, making it useful for ensuring the vehicle remains parked securely, Pneumatic parking brakes often act as an additional safety measure, further adding to the safety of the vehicle. Pneumatic parking brake systems also provide benefits with regard to durability. This makes them particularly attractive for use with commercial vehicles that undergo frequent parking brake engagements.

A parking brake system that is pneumatically operable often includes a cylinder having a parking brake chamber, wherein a change in pressure in the parking brake chamber causes brake shoes to engage. When the parking brake is released, the pressure in the parking brake chamber is changed again, causing the brake shoes to disengage,

In some situations, it is possible for the change in the parking brake chamber being such that the brake shoe or a brake pad or bake lining does not completely disengage. One situation is when the operation of a parking brake operation device by a driver is not fully correct and causes a pressure change in the parking brake chamber which does not cause full disengagement. Another situation can exist in parking brake systems in which an increase in pressure in the parking brake chamber causes disengagement of the brake shoe or a brake pad or bake lining, and a decrease in the pressure in the parking brake chamber causes engagement of the brake shoe or a brake pad or bake lining. Such parking brake systems offer advantages such as lending themselves to integration of parking brake and service brake functions in a cylinder that is responsive to both operation of a parking brake operation device by the driver and operation of a service brake operation device by the driver. However, a leak of the parking brake chamber can in this case cause unintentional engagement of the brake shoe or a brake pad or bake lining.

When a vehicle is driven while the parking brake is not completely released, several problems can occur. The brake shoe or the brake pad or the brake lining can rub against a rotor or drum of the braking system, causing excessive friction and wear. Continued driving with the parking brake partially engaged can also generate excessive heat in the braking system. This excessive heat can lead to a variety of issues and potential damage to the vehicle, such as causing the brake shoe or a brake pad or brake lining to wear down at an accelerated rate and may even lead to a fire hazard. This can result in reduced braking efficiency. The heat generated by driving with the parking brake engaged can potentially damage other components in the braking system, such as the calipers, pistons, or rotors. These parts may become warped or distorted, leading to issues with braking performance and requiring more complex repair work. To mitigate the risk of such situations, some vehicles are equipped with a human machine interface that is controlled to output a warning if the parking brake is not fully disengaged. However, such a solution does not provide a reliable safeguard against the vehicle being operated in a manner that has the potential of causing damage when the parking brake is not fully disengaged,

DE 10 2008 033 696 B4 discloses a pressure supply system including a control device operative to control a solenoid valve to block operation of a parking brake.

In view of the above, there is still a need for enhanced braking systems.

### SUMMARY

It is an object of the disclosure to provide an enhanced control device and an enhanced method of controlling a vehicle. It is an object of the disclosure to provide a control device and a control method that can reduce the risk of damage to braking system components in case of the vehicle being driven even though the parking brake is not completely disengaged.

The aforementioned objects are, for example, achieved via a control device, a vehicle system, and a control method according to the disclosure,

According to an aspect, there is provided a control device for a vehicle, the vehicle having a brake cylinder having a parking brake chamber configured such that a brake state is controllable by a pressure in the parking brake chamber. The control device includes at least one processing circuit configured to trigger a torque limiting action to limit an engine torque in response to a trigger condition that is dependent at least on the pressure in the parking brake chamber.

Various effects and advantages are attained by the control device. The control device is configured to take into consideration at least the pressure in the parking brake chamber to determine whether a mitigating action that includes limiting engine torque is to be performed. Thus, the control device can cause engine torque to be limited depending on whether the pressure in the parking brake chamber is such that a brake shoe or brake pad or brake lining of the parking brake is not fully disengaged. By causing a torque limiting action to be performed, in dependence on at least the pressure in the parking brake chamber, the control device can prevent further acceleration of the vehicle, mitigating the risk of overheating of the parking brake while allowing the vehicle to drive with a speed that does not incur a significant risk of overheating,

The at least one processing circuit may be configured to compare the pressure in the parking brake chamber to a threshold pressure to determine whether the trigger criterion is fulfilled.

Thereby, the control device is configured to cause the torque limiting action to be performed selectively dependent on whether the pressure in the parking brake chamber is such that the brake shoe or brake pad or brake lining is completely disengaged. The risk of a damage being caused to a braking system when driving with a not fully disengaged parking brake is mitigated. Safety is enhanced.

The control device may be configured such that the threshold pressure is adjustable.

Thereby, the control device provides configurability. The threshold pressure may be adjustable depending on the type of the vehicle in which the control device is to be installed, the vehicle load of the vehicle in which the control device is installed, and/or a wear state of the brake pad or brake lining.

The control device may include a storage system configured to store the threshold pressure. The control device may include a storage system interface configured to provide write access to the storage system to allow the threshold pressure to be written into or overwritten in the storage system.

Thereby, the control device provides configurability. The threshold pressure may be adjustable depending on the type of the vehicle in which the control device is to be installed, the load of the vehicle in which the control device is installed, and/or a wear state of the brake pad or brake lining.

The control device may be configured such that the trigger condition is dependent both on the pressure in the parking brake chamber and a speed of the vehicle.

Thereby, the control device is configured to cause the torque limiting action to be performed selectively dependent on whether the pressure in the parking brake chamber is such that the brake shoe or brake pad or brake lining is completely disengaged and further dependent on whether the vehicle speed is in a range at which the partial or full engagement of the brake shoe or brake pad or brake lining has the potential of causing permanent damage to the braking system. The risk of a damage being caused to the braking system when driving with a not fully disengaged parking brake is mitigated, while allowing the vehicle to accelerate as long as the vehicle speed is in a speed range for which the partial or full engagement of the brake shoe or brake pad or brake lining does not have a significant potential of causing severe (for example, permanent and/or non-reversible) damage to the braking system. This enhances safety while facilitating maintenance to be performed, by allowing the vehicle to accelerate as long as the vehicle speed is in a speed range for which the partial or full engagement of the brake shoe or brake pad or brake lining does not have a significant potential of causing severe damage to the braking system.

The at least one processing circuit may be configured to compare a vehicle speed to at least one speed threshold to determine whether the trigger condition is fulfilled.

Thereby, the control device is configured to cause the torque limiting action to be performed selectively dependent on whether the pressure in the park brake chamber and the vehicle speed are such that further acceleration has a potential of causing severe (for example, permanent and/or non-reversible) damage to the parking brake system. This enhances safety while facilitating maintenance to be performed, by allowing the vehicle to accelerate on its way to a repair facility (for example, a garage), as long as the vehicle speed is in a speed range for which the partial or full engagement of the brake shoe or brake pad or brake lining does not have a significant potential of causing severe damage to the braking system.

The at least one processing circuit may be configured to trigger the torque limiting action in response to determining that the pressure in the parking brake chamber is less than the threshold pressure.

Thereby, the control device is configured for use in a parking brake system in which the cylinder is configured such that a decrease in pressure in the parking brake chamber corresponds to engagement of the parking brake. The control device is configured to mitigate the effects of an unintentional engagement of the parking brake caused by a leak in the parking brake chamber in such a parking brake system.

The at least one processing circuit may be configured to trigger the torque limiting action in response to determining that the pressure in the parking brake chamber is less than the threshold pressure and that the vehicle speed is greater than a first threshold speed.

Thereby, the control device can cause engine torque to be limited (thus preventing the vehicle from accelerating) selectively only if the pressure in the parking brake chamber is such that the parking brake is not in a fully disengaged state and if the vehicle speed is such that there is a risk of overheating due to the (partial) engagement of the parking brake,

The at least one processing circuit may be configured to cause the torque limiting action to cease in response to a second trigger criterion different from the trigger criterion, the second trigger criterion being dependent at least on a vehicle speed.

Thereby, the control device is configured to not only cause the torque limiting action to be initiated but to also stop the torque limiting action when the vehicle speed is such that there is no risk of severe damage when driving with a parking brake that is partially or fully engaged. This facilitates the vehicle to drive to a location at which maintenance is performed, while still safeguarding safety.

The at least one processing circuit may be configured to cause the torque limiting action to cease in response to determining that the vehicle speed is less than a second threshold speed, wherein the second threshold speed is less than the first threshold speed.

Thereby, the control device is configured to not only cause the torque limiting action to be initiated but to also stop the torque limiting action when the vehicle speed is such that there is no risk of severe damage when driving with a parking brake that is partially or fully engaged. This facilitates the vehicle to drive to a location at which maintenance is performed, while still safeguarding safety.

The control device may include the storage system configured to store the threshold pressure, the first threshold speed and/or the second threshold speed. The control device may include a storage system interface configured to provide write access to the storage system to allow the first threshold speed and/or the second threshold speed to be written into or overwritten in the storage system.

Thereby, the control device provides configurability. The first threshold speed and/or the second threshold speed may be adjustable depending on the type of the vehicle in which the control device is to be installed, the load of the vehicle in which the control device is installed, and/or a wear state of the brake pad or brake lining.

The control device may further include a vehicle bus interface configured to communicatively interface the control device with a vehicle bus. The at least one processing circuit may be configured to control transmission of at least one message over the vehicle bus in response to the trigger condition to trigger the torque limiting action,

Thereby, the torque limiting action may be performed in an efficient manner and using field bus communication, by the control device transmitting at least one message to cause the torque limiting action to be performed.

The vehicle bus interface may include a Controller Area Network (CAN) interface.

The at least one processing circuit may be configured to generate a Torque Speed Control (TSC) message of the at least one message in response to the trigger condition to cause the engine torque to be limited.

Thereby, the torque limiting action may be performed in an efficient manner and using CAN bus communication, by the control device transmitting the TSC message to cause the torque limiting action to be performed.

The at least one processing circuit may be configured to generate the TSC message with a torque control, torque limit control and/or torque limit portion of the TSC message set to have a value which causes the torque limiting action to be performed.

Thereby, the torque limiting action may be performed in an efficient manner, using CAN bus communication, by the control device transmitting the TSC message to cause the torque limiting action to be performed.

The at least one processing circuit may be configured to generate a further Torque Speed Control (TSC) message in response to the second trigger condition (for example, in response to determining that the vehicle speed is less than the second threshold speed) to remove the limitation imposed on the engine torque.

Thereby, the torque limiting action may be removed in an efficient manner, using CAN bus communication.

The at least one processing circuit may be configured to generate the further TSC message with the torque control, torque limit control and/or torque limit portion of the further TSC message set to have a value which causes the torque limiting action to be lifted.

Thereby, the torque limiting action may be lifted in an efficient manner, using CAN bus communication, by the control device transmitting the further TSC message to cause the torque limiting action to be lifted.

The at least one processing circuit may include a pressure sensor interface configured to receive pressure data or at least one pressure signal indicative of the pressure in the parking brake chamber.

Thereby, the pressure in the parking brake chamber may be obtained by the control device.

The at least one processing circuit may be configured to check in a recurring manner (for example, periodically or aperiodically) whether the trigger condition is fulfilled.

Thereby, the control device can determine continually (that is, in an ongoing basis) during vehicle operation whether the torque limiting action is to be performed.

This is particularly useful in association with a parking brake system in which a decrease in pressure in the parking brake chamber causes engagement of the parking brake, as a potential leak can be detected by the recurring check.

The control device may be a braking system control device, such as a parking brake system control device.

Thereby, the function of mitigating risk of damage in case of a not fully disengaged parking brake can be integrated into the braking system control device, The control device may be an electropneumatic control device and/or may include at least one pneumatic interface configured to supply pressure to the parking brake chamber and/or perform an exhaust operation to reduce pressure in the parking brake chamber via the control device.

Thereby, the function of mitigating risk of damage in case of a not fully disengaged parking brake can be integrated into an electropneumatic control device associated with the cylinder.

According to a further aspect of the disclosure, a vehicle system according to an embodiment includes a braking system including a brake cylinder. The brake cylinder includes a parking brake chamber configured such that a brake state is controllable by a pressure in the parking brake chamber. The braking system further includes a pressure sensor configured to sense the pressure in the parking brake chamber, and the control device of any aspect or embodiment. The control device is communicatively coupled to the pressure sensor and is configured to determine, based on the pressure in the parking brake chamber, when the torque limiting action is to be triggered.

Various effects and advantages are attained by the vehicle system. The vehicle system includes the control device configured to take into consideration at least the pressure in the parking brake chamber to determine whether a mitigating action that includes limiting engine torque is to be performed. Thus, the control device can cause engine torque to be limited depending on whether the pressure in the parking brake chamber is such that a brake shoe or brake pad or brake lining of the parking brake is not fully disengaged. By causing the torque limiting action to be performed, in dependence on at least the pressure in the parking brake chamber, the control device can prevent further acceleration of the vehicle, mitigating the risk of overheating of the parking brake while allowing the vehicle to drive with a speed that does not incur a significant risk of overheating.

The vehicle system may further include an engine, an engine control unit configured to control the engine, and a field bus (such as a CAN bus). The control device may be configured to communicatively interface with the engine control unit via the field bus to trigger the torque limiting action.

Thereby, the torque limiting action can be put in place by communication of the control device with the engine control unit over the field bus.

The engine control unit may be configured to receive a TSC message from the control device and may limit the torque of the engine based on the received TSC message. Limiting the torque may include limiting, by the engine control unit, the torque in accordance with a percentage (such as 10%) specified in the TSC message and/or limiting the torque to set the engine to idle mode. Limiting the torque by the engine control unit may include controlling the engine such that the torque does not increase even when an accelerator pedal is pressed.

Thereby, the torque limiting action may be performed in an efficient manner using the TSC message.

The engine control unit may be configured to receive the TSC message with a torque control, torque limit control and/or torque limit portion of the TSC message set to have a value which causes the torque limiting action to be performed.

Thereby, the torque limiting action may be performed in an efficient manner, using CAN bus communication,

The engine control unit may be configured to receive the further TSC message and may lift the torque limiting action in response to the further TSC message, with the further TSC message being received, for example, in response to determining that the vehicle speed is less than the second threshold speed.

Thereby, the torque limiting action may be removed in an efficient manner, using CAN bus communication.

The engine control unit may be configured to receive the further TSC message with a torque control, torque limit control and/or torque limit portion of the further TSC message set to have a value which causes the torque limiting action to be lifted.

Thereby, the torque limiting action may be lifted in an efficient manner, using CAN bus communication.

The vehicle system may further include a brake shoe having arranged thereon a brake pad or brake lining and configured to engage a brake drum responsive to a change in pressure in the parking brake chamber.

According to a further aspect of the disclosure, there is provided a vehicle including the control device or the vehicle system according to an aspect or embodiment. The vehicle may be a commercial vehicle, for example, a truck or bus.

Thereby, the effects attained by the control device or the vehicle system are attained in association with, for example, a commercial vehicle in which the risk of overheating may be particularly pronounced when the park brake is not fully disengaged.

According to a further aspect of the disclosure, a method of controlling a vehicle is provided. The vehicle includes a brake cylinder. The brake cylinder includes a parking brake chamber configured such that a brake state is controllable by a pressure in the parking brake chamber. The method includes triggering, by a control device, a torque limiting action to limit an engine torque in response to a trigger condition that is dependent at least on the pressure in the parking brake chamber.

Various effects and advantages are attained by the method. The method is configured to take into consideration at least the pressure in the parking brake chamber to determine whether a mitigating action that includes limiting engine torque is to be performed. Thus, the method can cause engine torque to be limited depending on whether the pressure in the parking brake chamber is such that a brake shoe or brake pad or brake lining of the parking brake is not fully disengaged. By causing the torque limiting action to be performed, in dependence on at least the pressure in the parking brake chamber, the method can prevent further acceleration of the vehicle, mitigating the risk of overheating of the parking brake while allowing the vehicle to drive with a speed that does not incur a significant risk of overheating.

The method may be performed by or using the control device, the vehicle system, or the vehicle according to any aspect or embodiment.

Features that may optionally be used in the method and the technical effects attained thereby correspond to the features described in association with the control device, the vehicle system, and the vehicle according to aspects or embodiments. For illustration, the method may include performing the torque limiting action based on the trigger condition that is dependent on both the pressure in the parking brake chamber and on the vehicle speed, and lifting the torque limiting action based at least on the vehicle speed, as discussed in association with the control device.

The method may be a method of reducing the risk of overheating of braking system components in case of a leak in the parking brake chamber of the cylinder.

According to a further aspect, there is provided a method of reducing the risk of overheating of at least one parking brake system component of a vehicle that includes a brake cylinder. The brake cylinder includes a parking brake chamber configured such that a parking brake state is controllable by a pressure in the parking brake chamber. The method includes triggering, by a control device, a torque limiting action to limit an engine torque in response to a trigger condition that is dependent on the pressure in the parking brake chamber and on the vehicle speed. The method includes lifting, by the control device, the torque limiting action in response to a second trigger condition that is dependent on at least the vehicle speed.

The method may be operative to reduce the risk of overheating in case of a decrease in pressure in the parking brake chamber, which may be caused by a leak in the parking brake chamber.

According to a further aspect, there is provided a method of using the control device, the vehicle system, or the vehicle according to an aspect or embodiment to reduce the risk of overheating of at least one parking brake system component.

Various effects and advantages are attained by these method. These method take into consideration at least the pressure in the parking brake chamber to determine whether a mitigating action is to be performed that includes limiting engine torque. Thus, the method can cause engine torque to be limited depending on whether the pressure in the parking brake chamber is such that it can cause overheating due to friction, By causing a torque limiting action to be performed, in dependence on at least the pressure in the parking brake chamber, the method can prevent further acceleration of the vehicle, mitigating the risk of overheating of the parking brake while allowing the vehicle to drive with a speed that does not incur a significant risk of overheating.

Various effects and advantages are attained by the control device, vehicle system, vehicle, and methods disclosed herein. For illustration, the control device, vehicle system, vehicle, and method disclosed herein mitigates the risk of undesired overheating when a vehicle operates with a parking brake that is not fully disengaged. The control device, vehicle system, vehicle, and method disclosed herein allow the vehicle to drive to a location at which maintenance can be performed, while controlling engine torque so as to mitigate the risk of undesired overheating.

### BRIEF DESCRIPTION OF DRAWINGS

The invention will now be described with reference to the drawings wherein:

FIG. 1 is a schematic representation of a vehicle system including a control device;

FIG. 2 is a schematic representation of a vehicle system including the control device;

FIG. 3 is a flow chart of a method;

FIG. 4 is a flow chart of a method;

FIG. 5 is a flow chart of a method;

FIG. 6 is a schematic representation of pressure in a parking brake chamber as a function of time;

FIG. 7 is a schematic representation of pressure in a parking brake chamber as a function of time;

FIG, 8 is a schematic representation of vehicle speed as a function of time;

FIG. 9 is a schematic representation of a vehicle system including the control device;

FIG. 10 is a schematic representation of a vehicle system including the control device;

FIG. 11 is a schematic representation of a logic of the control device;

FIG. 12 is a schematic representation of a vehicle system including the control device; and,

FIG. 13 is a schematic representation of a vehicle including the control device.

### DETAILED DESCRIPTION

Embodiments of the disclosure will be described with reference to the drawings. In the drawings, similar or identical reference signs designate elements with similar or identical configuration and/or function.

To avoid repetition in the figures and the description of the various aspects and illustrative embodiments, it is be understood that many features are common to several aspects and embodiments. Omission of an aspect from a description or figure does not imply that the aspect is missing from embodiments that incorporate that aspect. Instead, the aspect may have been omitted for clarity.

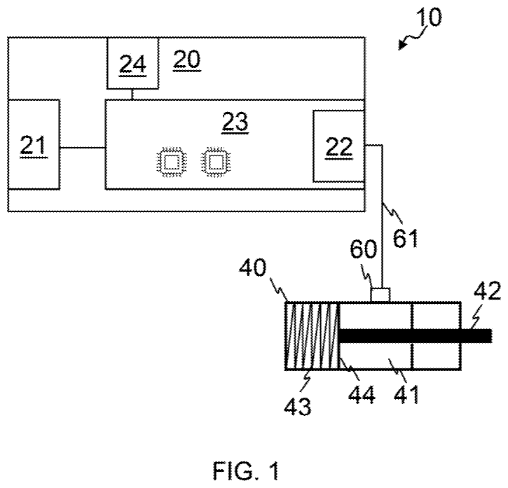

FIG. 1 shows a schematic view of a vehicle system 10 including a control device 20 for a vehicle, such as a commercial vehicle or other utility vehicle. The vehicle system 10 may be a braking system, such as a parking brake system. The vehicle system 10 may further include a cylinder 40 operative to cause engagement or disengagement of a brake shoe or brake pad or brake lining or other brake element. The cylinder 40 may be a spring brake cylinder 40 including a spring 43. The cylinder 40 has defined therein a parking brake chamber 41. The cylinder 40 is configured such that a change in pressure in the parking brake chamber 41 effects displacement of a piston 42, with the piston 42 being operative to cause engagement or disengagement of a brake shoe or brake pad or brake lining or other brake element. The cylinder 40 may include a separation member 44 displaceable under action of the pressure in the parking brake chamber 41. The cylinder 40 may be configured such that displacement of the separation member 44, under the influence of the force exerted thereon by the spring 43 and under the influence of the pressure in the parking brake chamber 41, causes displacement of the piston 42. While not explicitly shown in FIG. 1, the cylinder 40 may be a combined parking brake and service brake cylinder, as will be explained in more detail with reference to FIG. 12.

The control device 20 includes at least one processing circuit 23 operative to perform a mitigating action responsive to an operation scenario in which the pressure in the parking brake chamber 41 is such that there is a risk of overheating during driving operation of the vehicle. More specifically, the at least one processing circuit 23 is operative to cause a torque limiting action to be performed to limit an engine torque of an engine of the vehicle in response to determining that a trigger condition is fulfilled. The trigger condition is dependent at least on a pressure in the parking brake chamber 41. To determine whether the pressure in the parking brake chamber 41 such that there is a risk of friction-induced overheating when the vehicle drives, the at least one processing circuit 23 is configured to evaluate at least the pressure in the parking brake chamber 41. The at least one processing circuit 23 may include or may be communicatively coupled to a sensor interface 22 which is coupled to the pressure sensor 60 to receive pressure data or a pressure signal indicative of the pressure in the parking brake chamber 41. The pressure sensor 60 may be coupled to the control device 20 via a signal line 61 or data bus 61. The at least one processing circuit 23 may be configured such that the torque limiting action is triggered responsive to the trigger criterion, with the trigger criterion being dependent on both the pressure in the parking brake chamber 41 and a vehicle speed of the vehicle. The at least one processing circuit 23 may be configured to retrieve one or several thresholds for use in determining whether a threshold pressure-based criterion is fulfilled and/or for use in determining whether at least one threshold speed-based criterion is fulfilled. The control device 20 may include a storage system 24 operative to store the one or several thresholds in a nonvolatile manner. The at least one processing circuit 23 may be configured to cause the torque limiting action to be performed selectively dependent on whether the pressure in the parking brake chamber 41 fulfills a threshold pressure-based criterion and whether the vehicle speed fulfills a first speed-based criterion.

In order to trigger the torque limiting action, the at least one processing circuit 23 may be configured to generate a message for transmission over a field bus and to output the generated message over a field bus interface 21. Accordingly, the control device 20 may include a field bus interface 21 with which the at least one processing circuit 23 is communicatively coupled to output the message to trigger the torque limiting action. The field bus interface 21 may be or may include a Controller Area Network (CAN) interface.

The control device 20 may be configured such that it is not only operative to cause a torque limiting action to be performed, based on the trigger criterion that is dependent at least on the pressure in the parking brake chamber 41, but that it is additionally configured to cause the torque limiting action to be lifted. Thus, the at least one processing circuit 23 may be configured to cause the torque limiting action to be lifted selectively dependent on whether the vehicle speed fulfills a second speed-based criterion, with the second speed-based criterion being different from the first speed-based criterion,

The threshold pressure-based criterion may have various implementations, depending on the configuration and operation of the cylinder 40. For illustration, if the cylinder 40 is configured in such a manner that a decrease in pressure in the parking brake chamber 41 causes a brake shoe or brake lining or brake pad to engage, the control device 20 may be configured to cause the torque limiting action to be performed if the pressure in the parking brake chamber 41 is less than a threshold pressure or not more than the threshold pressure. The control device 20 may be configured to cause the torque limiting action to be performed selectively if both the pressure in the parking brake chamber 41 is less than the threshold pressure and a vehicle speed of the vehicle is greater than or at least equal to a first threshold speed. Other threshold-based criteria may be employed for other configurations of the cylinder 40. For illustration, if the cylinder 40 is configured in such a manner that an increase in pressure in the parking brake chamber 41 causes the brake shoe or brake pad or brake lining to engage, the control device 20 may be configured to cause the torque limiting action to be performed selectively if the pressure in the parking brake chamber is greater than or not less than the threshold pressure and the vehicle speed is greater than or at least equal to a first threshold speed.

To cause the torque limiting action and/or to lift the torque limiting action after it has been imposed, the control device 20 may be configured to transmit a CAN message and, more specifically, a Torque Speed Control (TSC) message. The TSC message is a data frame that contains information related to engine torque control. The control device 20 may use this data frame to both limit engine torque and lift limitations on engine torque (with at least some field being set differently to cause the torque limiting action to be performed and to lift the limitation, respectively).

To cause a torque limiting action to be performed, the control device 20 can generate and output a TSC message to impose a restriction on the maximum engine torque output. An engine control unit responsible for engine control and management is configured to receive the TSC message and interpret the torque limit values specified within it. If the requested torque is higher than the limit set by the TSC message, the engine control unit limits the torque output to ensure it stays within the constrained range. This can be useful in situations where excessive torque could potentially lead to further speed increase that has the potential of causing overheating after the control device 20 has determined that the pressure in the parking brake chamber 41 is such that there is a risk of friction-induced overheating in the braking system.

To lift an engine torque limitation, the control device 20 can generate and output a further TSC message to override the torque limitations set by the TSC message previously output by the control device 20. The further TSC message can be generated to lift the torque limitation, enabling the engine to deliver higher torque output again.

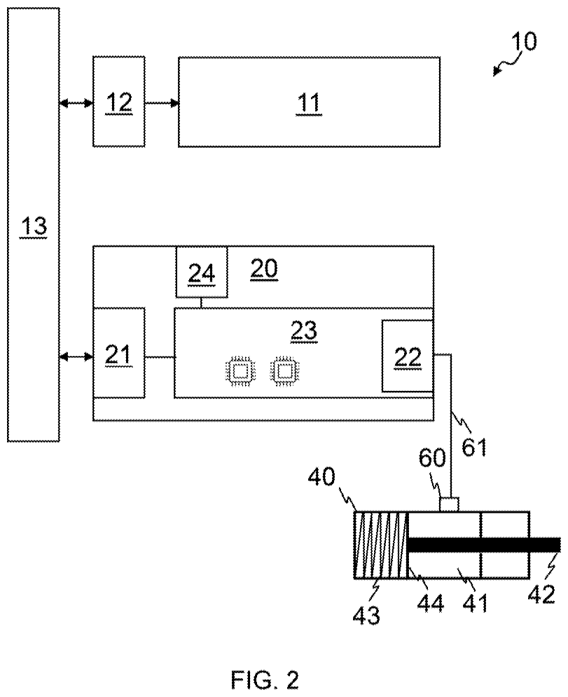

FIG. 2 shows a schematic representation of the vehicle system 10. The vehicle system 10 includes the cylinder 40, the pressure sensor 60, and the control device 20, which may be configured and operative as previously described in association with FIG. 1. The vehicle system 10 further includes a field bus 13, which may be a CAN bus. The vehicle system 10 includes an engine control unit 12 communicatively coupled to the field bus 13. The vehicle system 10 includes an engine 11.

The control device 20 may be configured to cause a torque limiting action to be performed, based on the pressure in the parking brake chamber 41 and further optionally based on a vehicle speed, by generating a TSC message and transmitting the TSC message to the engine control unit 12 via the field bus 13 (for example, the CAN bus). The engine control unit 12 is configured to limit torque output of the engine 11 in accordance with the received TSC message. For illustration, the control device 20 may be configured to generate the TSC message and/or the engine control unit 12 may be configured to interpret the TSC message in such a manner that the torque output of the engine 11 is limited to a certain percentage of the maximum or nominal engine output torque, such as 10% of the maximum or nominal engine output torque, or that the torque output of the engine 11 is limited to a torque output as required for idle mode operation of the engine 11.

The control device 20 may be configured to generate the further TSC message and/or the engine control unit 12 may be configured to interpret the further TSC message in such a manner that the torque limitation of the engine 11 is lifted again, if the control device 20 determines that the criterion for lifting the torque limitation again is fulfilled.

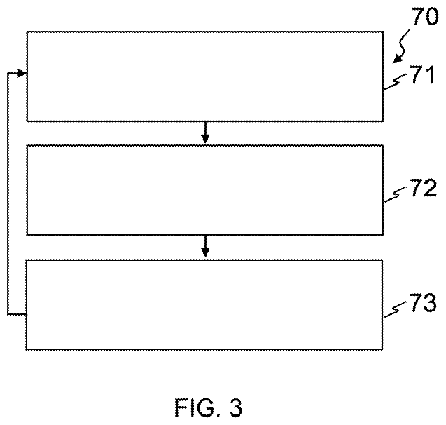

FIG. 3 shows a flow chart of a method 70 of controlling a vehicle. The method 70 may be performed automatically by or using the control device 20 and/or the vehicle system 10.

At process block 71, the control device 20 obtains pressure data or a pressure signal indicative of the pressure in the parking brake chamber 41. Obtaining the pressure data or pressure signal may include actively querying the pressure sensor 60 for the pressure data or pressure signal. Obtaining the pressure data or pressure signal may include monitoring for the pressure data or pressure signal from the pressure sensor 60.

At process block 72, the control device 20 determines whether a trigger condition for causing a torque limiting action to be performed is fulfilled. The trigger condition is dependent at least on the pressure in the parking brake chamber. The trigger condition may be dependent on both the pressure in the parking brake chamber 41 and the vehicle speed. Determining whether the trigger condition is fulfilled may include performing a pressure threshold comparison in which the pressure in the parking brake chamber 41 is compared to a threshold pressure. Determining whether the trigger condition is fulfilled may include performing both the pressure threshold comparison in which the pressure in the parking brake chamber 41 is compared to the threshold pressure and performing a vehicle speed threshold comparison in which the vehicle speed is compared to a first threshold speed. Responsive to determining that the trigger condition, which depends at least on the pressure in the parking brake chamber 41, is fulfilled, the control device 20 causes the torque limiting action to be performed. Causing the torque limiting action to be performed may include generating and outputting the TSC message over the CAN bus 13 to request the engine control unit 12 to limit the output torque of the engine 11.

At process block 73, the control device 20 determines whether a second trigger condition for lifting the torque limiting action is fulfilled. The second trigger condition is dependent at least on the vehicle speed. Responsive to determining that the second trigger condition for lifting the torque limiting action is fulfilled, the control device 20 causes the torque limiting action to be lifted. Causing the torque limiting action to be lifted may include generating and outputting a further TSC message over the CAN bus 13 to request the engine control unit 12 to no longer impose the limit on the output torque of the engine 11 previously communicated at process block 72.

Process blocks 71, 72, and 73 may be repeated in a recurring manner during vehicle operation. For illustration, process block 71, 72, and 73 may be repeated periodically or a periodically, Process block 71, 72, and 73 may be repeated continually, that is, in an ongoing manner during vehicle operation.

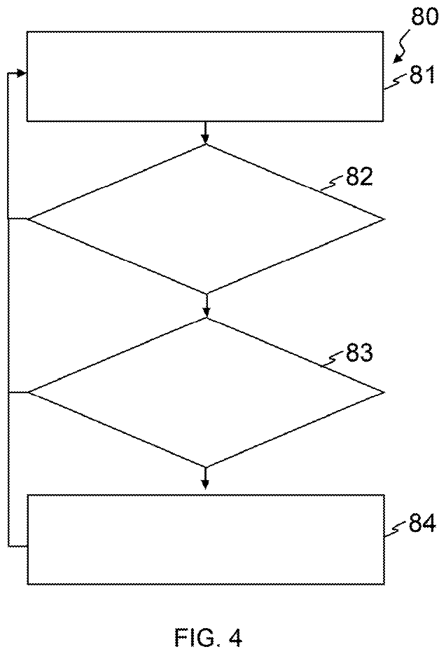

FIG. 4 shows a flow chart of a method 80 of controlling a vehicle. The method 80 may be performed automatically by or using the control device 20 and/or the vehicle system 10.

At process block 81, the control device 20 obtains pressure data or a pressure signal indicative of the pressure in the parking brake chamber 41 and a vehicle speed. Obtaining the pressure data or pressure signal may include actively querying the pressure sensor 60 for the pressure data or pressure signal. Obtaining the pressure data or pressure signal may include monitoring for the pressure data or pressure signal from the pressure sensor 60. Obtaining the vehicle speed may include receiving the vehicle speed over the CAN bus 13, over an interface different from the CAN bus interface 21 and/or using a vehicle speed sensor integrated in the control device 20.

At process blocks 82 and 83, the control device 20 determines whether a trigger condition for causing a torque limiting action to be performed is fulfilled. At process block 81, the control device 20 performs a pressure threshold comparison in which the pressure in the parking brake chamber 41 is compared to the threshold pressure. If the pressure threshold comparison shows that there is a risk that the brake shoe or brake pad or brake lining may cause friction-induced heating due to incomplete disengagement, the method 80 proceeds to process block 83. Otherwise, the method returns to process block 81.

At process block 83, the control device 20 performs a vehicle speed threshold comparison in which the vehicle speed is compared to the first threshold speed. If the first speed threshold comparison shows that the vehicle speed exceeds the first threshold speed or is at least equal to the first threshold speed, the method proceeds to process block 84. Otherwise, the method returns to process block 81.

At process block 84, the control device 20 causes the torque limiting action to be performed, based on the determinations made in the pressure threshold comparison at process block 82 and the first vehicle speed threshold comparison at process block 83. Causing the torque limiting action to be performed may include generating and outputting the TSC message over the CAN bus 13 to request the engine control unit 12 to limit the output torque of the engine 11. The TSC message may be generated to include a message indicating a percentage (such as 20% or less or 10% or less) to which the engine torque output is to be limited. The method returns to process block 81.

Process blocks 81, 82, 83, and 84 may be repeated in a recurring manner during vehicle operation. For illustration, process block 81, 82, 83, and 84 may be repeated periodically or a periodically. Process block 81, 82, 83, and 84 may be repeated continually, that is, in an ongoing manner during vehicle operation.

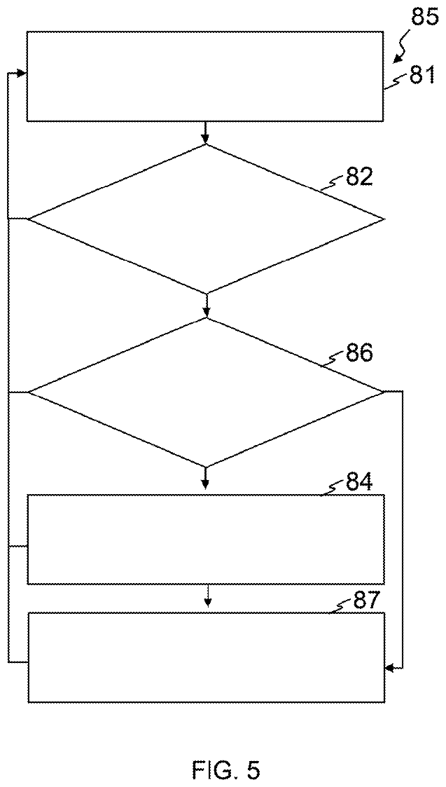

FIG. 5 shows a flow chart of a method 85 of controlling a vehicle. The method 85 may be performed automatically by or using the control device 20 and/or the vehicle system 10. Process blocks 81 and 82 may be implemented as described with reference to FIG. 4.

At process block 86, the control device 20 performs a vehicle speed threshold comparison in which the vehicle speed is compared to the first threshold speed and to the second threshold speed, with the second threshold speed being less than the first threshold speed. If the first speed threshold comparison shows that the vehicle speed exceeds the first threshold speed or is at least equal to the first threshold speed, the method proceeds to process block 84. If the second speed threshold comparison shows that the vehicle speed is less than the second threshold speed or is not more than the second threshold speed, the method proceeds to process block 87, Otherwise, if the vehicle speed does not exceed the first threshold speed or is not at least equal to the first threshold speed, and if the vehicle speed is not less than the second threshold speed or is at least equal to the second threshold speed, the method returns to process block 81.

At process block 84, the control device 20 causes the torque limiting action to be performed, based on the determinations made in the pressure threshold comparison at process block 82 and the first vehicle speed threshold comparison at process block 86. Causing the torque limiting action to be performed may include generating and outputting the TSC message over the CAN bus 13 to request the engine control unit 12 to limit the output torque of the engine 11. The TSC message may be generated to include a field indicating a percentage (such as 20% or less or 10% or less) to which the engine torque output is to be limited. The method returns to process block 81.

At process block 87, the control device 20 causes the torque limiting action to be lifted, based on the comparison of the vehicle speed to the second speed threshold at process block 86. Causing the torque limiting action to be lifted may include generating and outputting the further TSC message over the CAN bus 13 to request the engine control unit 12 to lift the limitation of the output torque of the engine 11.

Process blocks 81, 82, 86, 84, and 87 may be repeated in a recurring manner during vehicle operation. For illustration, process block 81, 82, 86, 84, and 87 may be repeated periodically or a periodically. Process block 81, 82, 86, 84, and 87 may be repeated continually, that is, in an ongoing manner during vehicle operation.

In the methods 70, 80, and 85 of FIG. 3, FIG. 4, and FIG. 5, respectively, the pressure threshold comparison may be implemented in such a manner that, if the cylinder 40 is configured such that a decrease in pressure in the parking brake chamber 40 one causes the brake shoe or brake pad or brake lining to engage, the control device 20 determines that there is a risk of unintentional overheating if the pressure in the parking brake chamber 40 one is less than or not more than the threshold pressure. Thereby, the control device 20 is configured to take appropriate counteraction not only when the driver does not correctly operate a parking brake operating device, but also if there is a leak in the parking brake chamber 40,

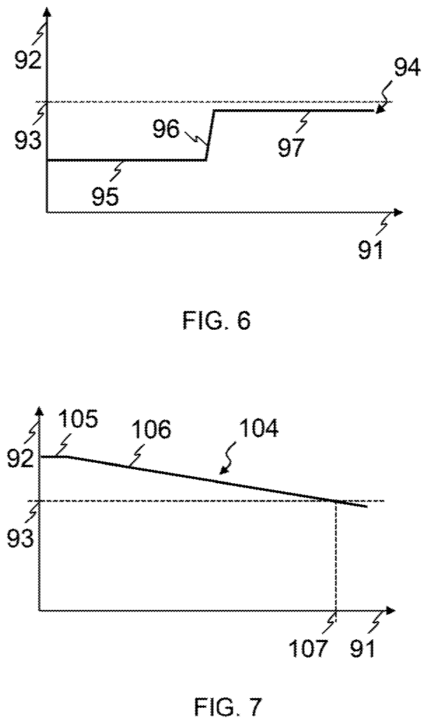

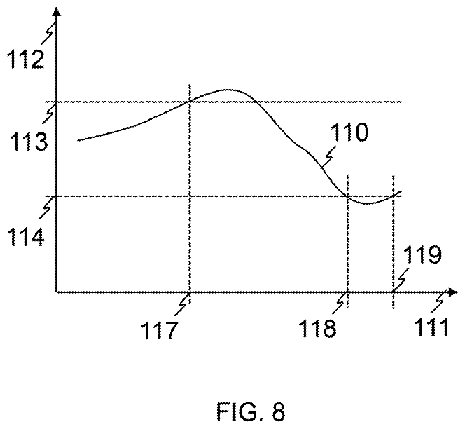

FIG. 6 and FIG. 7 respectively show, for exemplary situations, the pressure in the parking brake chamber 41 as a function of time to further illustrate and explain operation of the control device 20. In FIG. 6 and FIG. 7, a time dependent pressure 94, 95 is shown as a function of time along a time axis 91, with the orthogonal axis representing the pressure axis 92. In operation, the control device 20 compares the pressure 94, 95 to the threshold pressure 93.

FIG. 6 illustrates a situation in which a parking brake operating device is operated incorrectly by a driver, leading to an incomplete release. In the initial state, corresponding to a deliberately engaged parking brake, the pressure 94 in the parking brake chamber 41 is a first parking brake chamber pressure 95. The pressure 94 in the parking brake chamber 41 exhibits an increase 96 caused by the (insufficient) operation of the parking brake operating device by the driver. The increase 96 is such that, after the (insufficient) release operation performed by the driver, the pressure 94 in the parking brake chamber 41 is at a second parking brake chamber pressure 97 which is still less than the threshold pressure 93. At the second parking brake chamber pressure 97, there is a risk of friction-induced heating caused by the incomplete disengagement of, for example, the brake shoe or brake pad or brake liner. The control device 20 is configured to identify this issue by determining whether the trigger condition, which depends on the pressure 94 in the parking brake chamber 41, is fulfilled. The control device 20 initiates a mitigating action by causing the output torque of the engine 11 to be limited so as to prevent acceleration, at least if the vehicle speed is determined to be greater than or at least equal to the first threshold speed.

FIG. 7 illustrates a situation in which the parking brake chamber 41 has a leak, causing a gradual decrease in the pressure in the parking brake chamber 41. In the initial state, the pressure 104 in the parking brake chamber 41 is a first parking brake chamber pressure 105 which is sufficient to position the brake shoe or brake pad or brake liner such that there is no risk of friction-induced overheating even when the vehicle drives. The pressure 105 in the parking brake chamber 41 exhibits a decrease 106 caused by a leak of the parking brake chamber 41. The decrease 106 is such that the pressure 106 reaches the threshold pressure 93 at a time 107. The control device 20 detects that there is a risk of friction-induced heating caused by the incomplete disengagement of, for example, the brake shoe or brake pad or brake liner. The control device 20 is configured to identify this issue by determining whether the trigger condition, which depends on the pressure 104 in the parking brake chamber 41, is fulfilled. The control device 20 initiates a mitigating action at time 107 by causing the output torque of the engine 11 to be limited so as to prevent acceleration, at least if the vehicle speed is determined to be greater than or at least equal to the first threshold speed.

FIG. 8 shows a vehicle speed 110 as a function of time to further illustrate and explain operation of the control device 20. The time dependent vehicle speed 110 is shown as a function of time along a time axis 111, with the orthogonal axis representing the vehicle speed 112. In operation, the control device 20 compares the vehicle speed 110 to a first threshold speed 113 and a second threshold speed 114, at least if the control device 20 has ascertained that the pressure in the parking brake chamber 41 fulfills the pressure-based threshold criterion,

In response to the vehicle speed 110 reaching or exceeding the first threshold speed 113 (at torque limiting action trigger time 117), while the pressure in the parking brake chamber 41 is such that the brake shoe or brake pad or brake liner may cause friction-induced heating, the control device 20 causes the torque limiting action to be performed. Causing the torque limiting action to be performed may include generating and outputting the TSC message to cause the engine control unit 12 to restrict the output torque of the engine 11 in accordance with the TSC message. The torque limitation caused by the control device 20 may remain in place until the control device 20 lifts the torque limiting action. In this state, the vehicle is prevented from accelerating even when the accelerator pedal is pressed, until the control device 20 determines that the torque limiting action is to be lifted.

In response to the vehicle speed 110 reaching or falling below the second threshold speed 114 (at lifting torque limiting action time 118), the control device 20 causes the torque limiting action to be lifted. Causing the torque limiting action to be lifted may include generating and outputting the further TSC message to cause the engine control unit 12 to lift the limitation of the output torque of the engine 11 previously imposed by the control device 20.

The control device 20 may be configured such that, when the vehicle accelerates again to a vehicle speed greater than the second threshold speed 114 (at second threshold speed crossing time 119), no torque limiting action needs to be taken unless and until the vehicle speed reaches the first threshold speed 113.

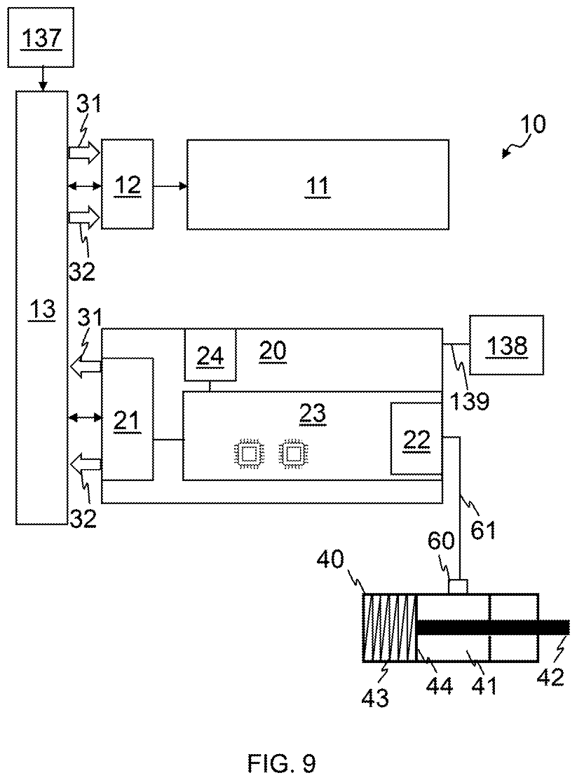

FIG. 9 is a schematic representation of the vehicle system 10. The control device 20 and the engine control unit 12 communicatively coupled to the CAN bus 13, with the CAN bus 13 communicatively interfacing the control device 20 and the engine control unit 12.

The at least one processing circuit 23 may be configured to generate the TSC message 31 in response to the trigger condition (which trigger condition is dependent at least on the pressure in the parking brake chamber 41 and a comparison of vehicle speed to the first threshold speed 113) to cause the engine torque to be limited, causing the engine control unit 12 to restrict the engine torque in accordance with the TSC message 31. The at least one processing circuit 23 may be configured to generate the TSC message with a torque control, torque limit control and/or torque limit portion of the TSC message set to have a value which causes the torque limiting action to be performed. The at least one processing circuit 23 may be configured to generate the TSC message as a TSC1 message. Thereby, the torque limiting action may be performed in an efficient manner, using CAN bus communication, by the control device transmitting the TSC message 31 to cause the torque limiting action to be performed.

The at least one processing circuit 23 may be configured to generate the further TSC message 32 in response to the second trigger condition (for example, in response to determining that the vehicle speed is less than the second threshold speed 114 or not greater than the second threshold speed 114) to remove the limitation imposed on the engine torque. The at least one processing circuit 23 may be configured to generate the further TSC 32 message with a torque control, torque limit control and/or torque limit portion of the TSC message set to have a value which causes the torque limiting action to be lifted. Thereby, the torque limiting action may be lifted in an efficient manner, using CAN bus communication, by the control device 20 transmitting the further TSC message 32 to cause the torque limiting action to be lifted.

The control device 20 may be configured to obtain the vehicle speed from a vehicle speed source 137, such as a vehicle speed sensor 137, for use in determining whether the torque limiting action is to be imposed, taking into account the pressure in the parking brake chamber, or whether the torque limiting action is to be lifted. The control device 20 may be configured to receive the vehicle speed over the CAN bus 13 or over a signal line or data connection different from the CAN bus 13.

The control device 20 may be configured to perform functions other than causing the torque limiting action to be initiated, based at least on the pressure in the parking brake chamber 41, and causing the torque limiting action to be lifted. For illustration, the control device 20 may be a braking system control device 20 coupled to a parking brake operating device 138 (such as a lever) via a pneumatic or electric operating device connection line 139. The control device 20 may include one or several pneumatic ports to perform a function such as a pressure modulator function, without being limited thereto.

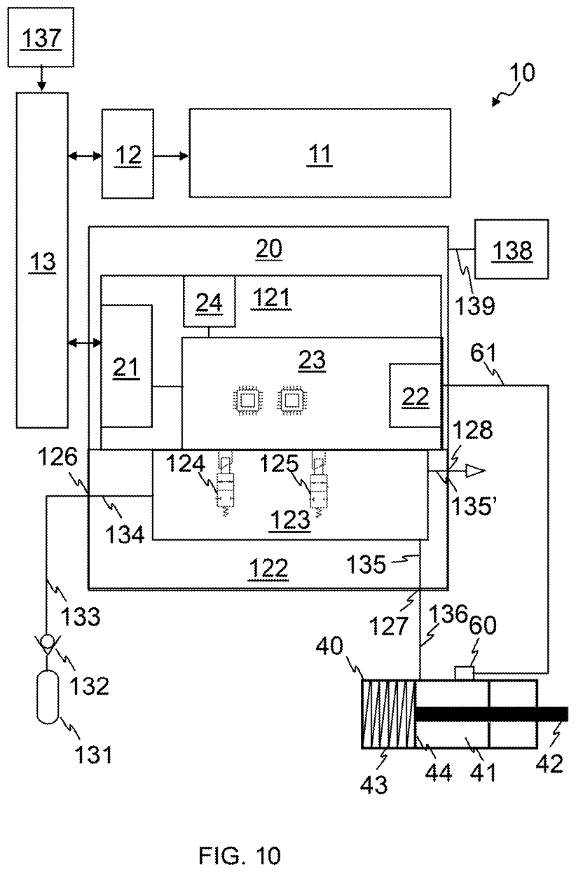

FIG. 10 is a schematic representation of the vehicle system 10 including the control device 20. The control device 20 includes an electronics portion 121 and a pneumatic portion 122. The electronics portion 121 includes the CAN bus interface 21, the at least one processing circuit 23, and the storage system 24. The electronics portion 121, which may be configured as an electronic control unit integrated into or attached to a housing that accommodates the pneumatics portion 122, may be operative to control one or several controllable components, such as solenoid valves 124, 125, of a controllable valve assembly 123 of the pneumatics portion 122.

The control device 20 may be configured to supply a pressure gas from a source, such as a pressure fluid reservoir 131, to the cylinder 40 and/or to exhaust gas from the cylinder 40 via an exhaust port 128 of the control device 120. The control device 20 may include an inlet port 126 configured to be connected to a first connection line 133, which is connected to the pressure fluid reservoir 131 via a check valve 132. The control device 20 may include an outlet port 127 configured to be fluidically connected to the cylinder 40 via a second connection line 136. The control device 20 may include a first fluid communication path 134 directly connected to the inlet port 126 and the controllable valve assembly 123. The control device 20 may include a second fluid communication path 135 directly connected to the outlet port 127 and the controllable valve assembly 123, The control device 20 may include a third fluid communication path 135′ directly connected to the exhaust port 128 and the controllable valve assembly 123.

The control device 20 may be configured such that the electronics portion 121 controls the controllable valve assembly 123 to selectively establish fluid communication of the outlet port 127 with the inlet port 126 and/or the exhaust port 128. The control device 20 may be configured such that the electronics portion 121 controls one or several solenoid valves 124, 125 of the controllable valve assembly 123, responsive to an operation of the parking brake operating device 138, to selectively establish fluid communication of the outlet port 127 with the inlet port 126 or the exhaust port 128 through the control device 20.

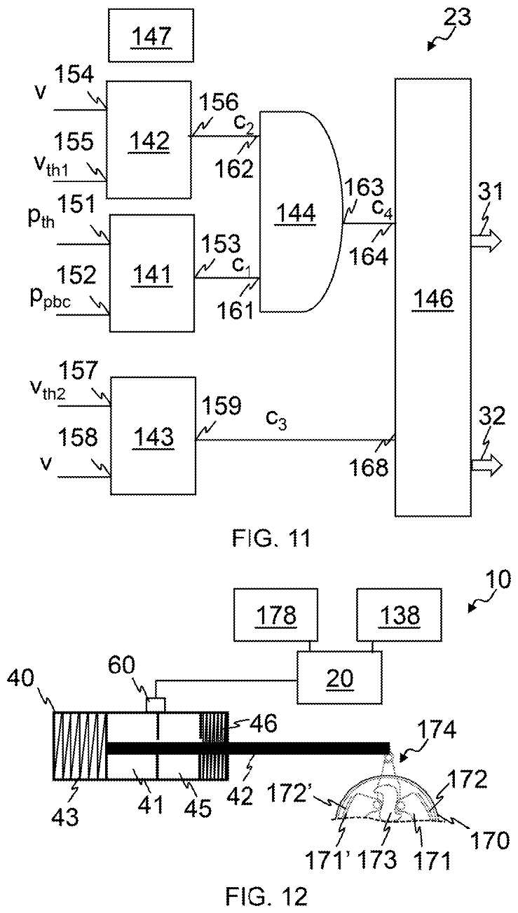

FIG. 11 shows a schematic representation of a logic of the at least one processing circuit 23. The logic of the at least one processing circuit 23 may include a first comparator logic 141, a second comparator logic 142, and a third comparator logic 143. While reference will be made to various signals in the description of FIG. 11, the term “signal,” as used with reference to FIG. 11, refers to a logical signal that can have a digital or analog representation.

The first comparator logic 141 may have a first input 151 configured to receive the pressure threshold (designated by signal pth), a further first input 152 configured to receive the pressure in the parking brake chamber 41 (designated by signal P_{pbc}), and a first output 153 configured to provide a first comparator output signal (designated by signal c₁) that depends on a comparison of the input signals of the first comparator logic 141, pₜₕ and p_{pbc}.

The second comparator logic 142 may have a second input 154 configured to receive the vehicle speed (designated by signal v), a further second input 155 configured to receive the first speed threshold (designated by signal Vₜₕ₁), and a second output 156 configured to provide a second comparator output signal (designated by signal c₃) that depends on a comparison of the input signals of the second comparator logic 142, v and vₜₕ₁.

The third comparator logic 143 may have a third input 157 configured to receive the second speed threshold (designated by signal Vₜₕ₂), a further third input 158 configured to receive the vehicle speed (designated by signal v), and a third output 159 configured to provide a third comparator output signal (designated by signal c₃) that depends on a comparison of the input signals of the third comparator logic 143, vₜₕ₂ and v.

The at least one processing circuit 23 may include a storage system interface 147 operative to retrieve the threshold pressure, the first threshold speed, and the second threshold speed from the storage system 24 and to provide them as inputs to the first comparator logic 141, the second comparator logic 142, and the third comparator logic 143. The storage system interface 147 may also be configured to perform a write operation to write or overwrite the thresholds in the storage system 24. Thus, the control device 20 may include a storage system interface 147 configured to allow the threshold pressure and the first and second threshold speeds to be written or overwritten, making the logic configurable based on, for example, vehicle type, vehicle load, and/or brake wear state, et cetera.

The at least one processing circuit 23 includes a logical AND gate 144 operative to combine the first comparator output signal c₁ and the second comparator output signal c₂. The logical AND gate 144 has an AND gate input 161 connected to the first comparator output 153 to receive the first comparator output signal c₁. The logical AND gate 144 has a further AND gate input 162 connected to the second comparator output 156 to receive the second comparator output signal c₂. The logical AND gate 144 is operative to provide, at its AND gate output 163, an AND gate output signal c₄ that indicates whether the trigger condition for causing the torque limiting action to be performed is fulfilled. The AND gate output signal C4 is indicative of a vehicle state in which both the pressure in the parking brake chamber 41 is such that there is a risk of friction-induced heating and the vehicle speed is greater than or at least equal to the first speed threshold Vth1.

The at least one processing circuit 23 includes a TSC message generator 146. The TSC message generator 146 may have a message generator input 164 connected to the AND gate output 163 of the logical AND gate 144 to receive the AND gate output signal c₄. The AND gate output signal c₄ is indicative of a vehicle state in which both the pressure in the parking brake chamber 41 is such that there is a risk of friction-induced heating and the vehicle speed is greater than or at least equal to the first speed threshold vₜₕ₁. In response to receiving the AND gate output signal ca having a value indicative of the pressure in the parking brake chamber 41 being such that there is a risk of friction-induced heating and the vehicle speed being greater than or at least equal to the first speed threshold vₜₕ₁, the TSC message generator 146 is configured to generate and output the TSC message 31 to cause the engine torque to be limited.

The TSC message generator may have a further message generator input 168 connected to the output 159 of the third comparator logic 143 to receive the third comparator output signal c₃. In response to the output signal c₃ indicating that the torque limiting action can be lifted, the TSC message generator 146 is configured to generate and output the further TSC message 32 to cause lifting of the engine torque limitation.

Various modifications of the logics of the at least one processing circuit 23 are possible. For illustration, more complex conditional logics may be implemented in which the further TSC message 32 to cause lifting of the engine torque limitation is generated conditionally dependent on that the at least one processing circuit 23 has previously issued the TSC message 31 to cause the torque limiting action. For further illustration, various criteria may be used for determining when the torque limiting action can be lifted, such as lifting the torque limiting action when the pressure in the parking brake chamber 41 has changed such that there is no longer a risk of friction-induced heating or when the vehicle speed has fallen to or below the second threshold speed 114 (in which case the at least one processing circuit 23 may include a logical OR gate receiving the first comparator output signal c₁ and the third comparator output signal c₂ as inputs and having a logical OR gate output connected to the further message generator input 168).

FIG. 12 shows a schematic representation of the vehicle system 10. The vehicle system 10 is configured in such a manner that the cylinder 40 is configured for performing both a parking brake operation and a service brake operation. Such cylinders are commercially available, for example, as so-called tristop cylinders. The cylinder 40 includes, in addition to the parking brake chamber 41, a service brake chamber 45 and a further bias spring 46. In response to operation of a service brake operating device 178, the piston 42 of the cylinder 40 is displaced towards a first direction (in FIG. 12 towards the right) to cause a right side displacement of the brake liner 172 or a brake pad 172 on a brake shoe 171 to engage a brake drum 170. Piston displacement is in this case effected by a change in pressure in the service brake chamber 45. The piston 42 effects displacement of the brake shoe 171 and the further brake shoe 171′ with the brake liner 172 and the further brake liner 172′ or the brake pad 172 and the further brake pad 172′ via a linkage 174 and an S-cam 173.

The cylinder 40 is configured such that, in response to operation of the parking brake operating device 138, the piston 42 of the cylinder 40 is displaced towards a second direction (in FIG. 12 towards the left) opposite the first direction to cause a left side displacement of the further brake liner 172′ or the further brake pad 172′ on the further brake shoe 171′ to engage the brake drum 170. As previously explained, this operation is dependent on the pressure in the parking brake chamber 41, which may be altered responsive to operation of the parking brake operating device 138. The pressure in the parking brake chamber 41 may also have changes that are not the result of a deliberate driver action, such as a pressure decrease in the parking brake chamber 41 that may be caused by a leak of the parking brake chamber 41.

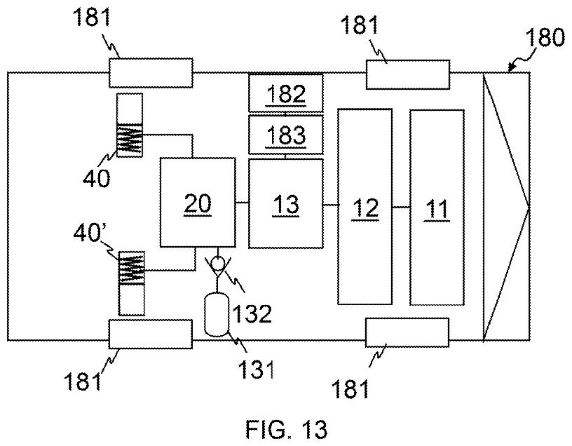

FIG. 13 shows a schematic representation of a vehicle 180. The vehicle 180 may be a commercial vehicle or another utility vehicle. The vehicle 180 has wheels 181, a spring brake cylinder 40 associated with at least one of the wheels 181, and a further spring brake cylinder 40′ associated with at least a further one of the wheel 181. The control device 20 to cause a torque limiting action in response to the pressure in the parking brake chamber of at least one of the spring brake cylinder 40 and the further spring brake cylinder 40′ being such that there is a risk of friction between the brake drum and the brake shoe or brake pad or brake liner.

The vehicle 180 may be configured to additionally provide a warning, alarm, or other status indication indicating that the parking brake is—possibly inadvertently—in an engaged state while the vehicle 180 is driving. To provide such an output via a human machine interface (HMI) 182 of the vehicle 180, the vehicle 180 may include an HMI controller 183 configured to control the HMI 182 based on the pressure in the parking brake chamber 41.

Various effects and advantages are attained by embodiments of the disclosure. For illustration, embodiments allow a vehicle to continue driving even though the pressure in the parking brake chamber is such that the brake shoe or brake pad or brake liner is possibly in an engaged position. At the same time, the risk of overheating is reduced by causing the torque limiting action. The torque limiting action can be caused in a vehicle-speed dependent manner, making it possible that sufficient engine torque output is available in cases in which, for example, the vehicle drives uphill at a speed lower than the first threshold speed (in which case the torque limiting action is not caused until the vehicle speed reaches or exceeds the first threshold speed), Thus, the techniques disclosed herein may provide an engine torque control that takes into account both the pressure in the parking brake chamber and vehicle speed, The techniques disclosed herein allow a limp home mode to be activated, with the limp home mode having an engine torque output that is deliberately limited or reduced as compared to the available torque output, ensuring that the vehicle remains in a safe operating condition.

The various thresholds discussed in association with the control device, vehicle system, and control method may vary somewhat, depending on the vehicle type, vehicle load, and/or other vehicle characteristics. For illustration, in some implementation, the threshold pressure may be 800 kPa or less, 700 kPa or less, 650 kPa or less, or 600 kPa. The first threshold speed may be 11 km/h or more, 12 km/h or more, 13 km/h or more, 14 km/h or more, or 15 km/h or more. The second threshold speed may be 10 km/h or less, 9 km/h or less, or 8 km/h or less.

The control device 20 and/or the engine control unit 12 may be configured such that the TSC messages may respectively be TSC1 messages.

Various modifications may be made in additional embodiments. For illustration, while the control device 20 may be a braking system control device which may have one or several pneumatic ports, the control device 20 may also be implemented as a braking system control device that does not have a pneumatic port. For further illustration, while the control device 20 may be configured to generate and output a TSC message (such as a TSC1 message for transmission over a CAN bus) and/or to a further TSC message (such as a further TSC1 message for transmission over the CAN bus), the control device 20 may be configured to use other field bus messages and/or proprietary buses or signal lines to cause the engine control unit 12 to restrict the output torque of the engine and/or to lift such a limitation. For still further illustration, the torque limiting action may include limiting the torque output to 10% or idle mode, without being limited thereto.

For further illustration, while the at least one processing circuit 23 may include a comparator logic having comparators and/or other gates that may be implemented in hardware, the at least one processing circuit 23 may include any one or any combination of integrated circuits, integrated semiconductor circuits, processors, controllers, application specific integrated circuits (ASICs), field programmable gate arrays (FPGAs), without being limited thereto. The at least one processing circuit 23 may include at least one programmable processing circuit configured to perform the processing discussed herein, when performing machine-readable instruction code (such as firmware which may be stored in the storage system 24 in a non-volatile manner).

For further illustration, while the parking brake may include brake shoes displaced by a cylinder piston via a linkage and S-cam, other configurations of the parking brake may be provided, such as a construction having a lamellar structure or other known parking brake configurations.

It is understood that the foregoing description is that of the preferred embodiments of the invention and that various changes and modifications may be made thereto without departing from the spirit and scope of the invention as defined in the appended claims.

### REFERENCES

10 vehicle system
11 engine
12 engine control unit
13 Controller Area Network (CAN) bus
20 control device
21 Controller Area Network (CAN) interface
22 sensor interface
23 at least one processing circuit
24 storage system
31 Torque Control Signal (TCS) message
32 further Torque Control Signal (TCS) message
40 cylinder
40′ further cylinder
41 parking brake chamber
42 piston
43 bias spring
44 displaceable member
45 service brake chamber
46 further bias spring
60 pressure sensor
61 signal line
70 method
71-73 process blocks
80 method
81-84 process blocks
85 method
86 process block
91 time axis
92 pressure axis
93 threshold pressure
94 time-dependent pressure in parking brake chamber
95 first parking brake chamber pressure
96 parking brake chamber pressure variation by incomplete parking brake release
97 second parking brake chamber pressure
104 time-dependent pressure in parking brake chamber
105 first parking brake chamber pressure
106 parking brake chamber pressure variation by parking brake chamber leak
107 initiation time of mitigating action
111 time axis
112 vehicle speed axis
113 first threshold speed
114 second threshold speed
117 torque limiting action trigger time
118 lifting torque limiting action time
119 second threshold speed crossing time
121 electronics portion
122 pneumatics portion
123 controllable valve assembly
124 solenoid valve
125 further solenoid valve
126 inlet port
127 outlet port
128 exhaust port
131 pressure fluid reservoir
132 check valve
133 first connection line
134 first fluid communication path
135 second fluid communication path
135′ third fluid communication path
136 second connection line
137 speed sensor
138 parking brake operation device
139 operation device connection line
141 first comparator logic
142 second comparator logic
143 third comparator logic
144 logical AND gate
146 TSC message generator
147 storage system interface
151 first input
152 further first input
153 first output
154 second input
155 further second input
156 second output
157 third input
158 further third input
159 third output
161 AND gate input
162 further AND gate input
163 AND gate output
164 message generator input
168 further message generator input
170 brake drum
171 brake shoe
171′ further brake shoe
172 brake lining or brake pad
172′ further brake lining or further brake pad
173 S-cam
174 linkage
178 service brake operation device
c₁ first comparator output signal
c₂ second comparator output signal
c₃ third comparator output signal
c₄ AND gate output signal
p_{pbc} parking brake chamber pressure
pₜₕ threshold pressure
v vehicle speed
vₜₕ₁ first threshold speed
vₜₕ₂ second threshold speed
180 vehicle
181 wheel
182 human machine interface (HMI)
183 HMI controller

1. A control device for a vehicle, the vehicle including a brake cylinder having a parking brake chamber configured such that a brake state is controllable by a pressure in the parking brake chamber, the control device comprising:
at least one processing circuit; and,
said at least one processing circuit being configured to trigger a torque limiting action to limit an engine torque in response to a trigger condition that is dependent at least on the pressure in the parking brake chamber.

2. The control device of claim 1, wherein said at least one processing circuit is configured to compare the pressure in the parking brake chamber to a threshold pressure to determine whether the trigger condition is fulfilled.

3. The control device of claim 2, wherein the control device is configured such that the threshold pressure is adjustable.

4. The control device of claim 1, wherein said at least one processing circuit is configured to compare a vehicle speed to at least one speed threshold to determine whether the trigger condition is fulfilled.

5. The control device of claim 4, wherein
said at least one processing circuit is configured to compare the pressure in the parking brake chamber to a threshold pressure to determine whether the trigger condition is fulfilled;
said at least one processing circuit is configured to trigger the torque limiting action in response to determining:
that the pressure in the parking brake chamber is less than the threshold pressure; and,
that the vehicle speed is greater than a first threshold speed.

6. The control device of claim 5, wherein said at least one processing circuit is configured to cause the torque limiting action to cease in response to determining that the vehicle speed is less than a second threshold speed; and, the second threshold speed is less than the first threshold speed.

7. The control device of claim 1 further comprising:
a vehicle bus interface configured to communicatively interface the control device with a vehicle bus; and,
said at least one processing circuit being configured to control transmission of at least one message over the vehicle bus in response to the trigger condition to trigger the torque limiting action.

8. The control device of claim 7, wherein said vehicle bus interface includes a Controller Area Network interface; and, said at least one processing circuit is configured to generate a Torque Speed Control message of the at least one message in response to the trigger condition to cause the engine torque to be limited.

9. The control device of claim 1, wherein said at least one processing circuit includes a pressure sensor interface configured to receive pressure data or at least one pressure signal indicative of the pressure in the parking brake chamber.

10. The control device of claim 1, wherein said at least one processing circuit is configured to check in a recurring manner whether the trigger condition is fulfilled.

11. The control device of claim 1, wherein the control device is a braking system control device.

12. A vehicle system comprising:
a braking system including a brake cylinder, said brake cylinder including a parking brake chamber configured such that a brake state is controllable by a pressure in said parking brake chamber;
said braking system further including a pressure sensor configured to sense a pressure in said parking brake chamber;
said braking system further including a control device having at least one processing circuit;
said at least one processing circuit being configured to trigger a torque limiting action to limit an engine torque in response to a trigger condition that is dependent at least on the pressure in said parking brake chamber; and,
said control device being configured to be communicatively coupled to said pressure sensor and being configured to determine, based on the pressure in said parking brake chamber, when the torque limiting action is to be triggered.

13. The vehicle system of claim 12, further comprising:
an engine;
an engine control unit configured to control said engine;
a field bus; and,
said control device being configured to communicatively interface with said engine control unit via said field bus to trigger the torque limiting action.

14. A method of controlling a vehicle, the vehicle including a brake cylinder, the brake cylinder including a parking brake chamber configured such that a brake state is controllable by a pressure in the parking brake chamber, the method comprising:
triggering, by a control device, a torque limiting action to limit an engine torque in response to a trigger condition that is dependent at least on the pressure in the parking brake chamber.

15. The method of claim 14, wherein the control device includes at least one processing circuit configured to trigger the torque limiting action to limit the engine torque.

16. The method of claim 14, wherein:
the vehicle includes a vehicle system;
the vehicle system has a braking system including the brake cylinder, the brake cylinder including the parking brake chamber configured such that the brake state is controllable by the pressure in the parking brake chamber;
the braking system further includes a pressure sensor configured to sense the pressure in the parking brake chamber; and,
said braking system further includes a control device having at least one processing circuit;
said at least one processing circuit is configured to trigger the torque limiting action to limit the engine torque in response to the trigger condition that is dependent at least on the pressure in said parking brake chamber; and,
said control device is configured to be communicatively coupled to said pressure sensor and is configured to determine, based on the pressure in said parking brake chamber, when the torque limiting action is to be triggered.
